(19) United States
(12) Patent Application Publication
(10) Pub. No.: US 2013/0168326 A1
(43) Pub. Date: Jul. 4, 2013

(54) FLOCCULENT ADDITION AND MIXING RATE FOR SEPARATING A SLURRY

(71) Applicants: Nicolas-Alexandre Bouchard, Jonquiere (CA); Guy Peloquin, Jonquiere (CA); Renald Dufour, Jonquiere (CA)

(72) Inventors: Nicolas-Alexandre Bouchard, Jonquiere (CA); Guy Peloquin, Jonquiere (CA); Renald Dufour, Jonquiere (CA)

(73) Assignee: RIO TINTO ALCAN INTERNATIONAL LIMITED, Montreal, QC (CA)

(21) Appl. No.: 13/808,978

(22) PCT Filed: Jul. 7, 2011
(86) PCT No.: PCT/CA2011/000785

§ 371 Date: Mar. 19, 2013

(30) Foreign Application Priority Data
Jul. 9, 2010 (AU) 2010903056

(51) Int. Cl. B01D 21/01

(52) U.S. Cl. CPC B01D 21/01
USPC 210/738; 210/208; 210/201

(57) ABSTRACT

The invention concerns a method for separating solid and liquor components of a process slurry comprising solid material entrained in a liquor, said method comprising: (a) a pre-treatment step of adding a flocculent to the process slurry and mixing the flocculent and the slurry by selecting a higher extent of mixing in an early stage of said step than in a later stage of said step, and (b) a solid/liquor separation step of allowing separation of solid material, including aggregates of solid material, and liquor of said process slurry to produce process outputs of a clarified liquor and solid material with some entrained liquor. The invention also concernes a method and an apparatus for adding a flocculent to a process slurry.

### TECHNICAL FIELD

The present invention relates to a method and an apparatus for separating solid and liquor components of a process slurry, and in particular of a process slurry produced in a hydrometallurgical process such as a Bayer process in a plant for producing alumina.

More particularly, the present invention relates to a method and an apparatus for adding a flocculent to a process slurry, and in particular to a hydrometallurgical process slurry, such as a Bayer process slurry, to facilitate solid/liquor separation of the slurry.

The present invention relates particularly, although by no means exclusively, to a method and an apparatus for adding a flocculent to a process slurry produced in digestion units of Bayer process plants to facilitate solid/liquor separation of the slurry. The following description of the invention focuses on Bayer process slurries. However, it is emphasised that the present invention has broader application than this and relates generally to hydrometallurgical process slurries.

### BACKGROUND ART

The Bayer process comprises the following major process steps.
(a) Digesting bauxite in caustic soda in digestion units and forming a high temperature and high pressure process slurry in the form of (i) a liquor containing sodium aluminate in solution and (ii) solid material, principally particles of inert iron and titanium oxides and silica compounds, entrained in the liquor.
(b) Separating the solid and the liquor components of the process slurry.
(c) Precipitating alumina trihydrate from the liquor.
(d) Calcining the precipitated aluminium trihydrate and forming alumina.

The high temperature and high pressure process slurry produced in the digestion units is discharged from the units and flash-cooled to atmospheric pressure in a series of tanks operating at successively lower pressures. The flash steam generated in the flash tanks is used beneficially in the Bayer process, typically to pre-heat caustic soda used in the digestion tanks.

Solid/liquor separation step (b) includes the use of settling tanks to allow separation of solid and liquor components of the process slurry. Flocculents such as starch or synthetic polymers are generally added to the process liquor in the tanks to promote the settling of solids in the tanks.

It is important that the liquor separated from the process slurry in solid/liquor separation step (b) be of high purity since impurities that are carried with the liquor into later steps of the alumina recovery process, namely the precipitation and calcination steps, reduce the purity of the resultant alumina and/or make operation of the later recovery stages more difficult.

For instance the presence of inorganic suspended solids in the liquor is liable to lead to the contamination of the alumina by, for instance, iron whilst the presence of dissolved organic materials such as humates is liable to interfere with precipitation during the recovery processes.

The above discussion is not to be taken as an admission of the common general knowledge in Australia or elsewhere.

The United States patent U.S. Pat. No. 4,678,585 describe a process for flocculating red muds from a Bayer alumina recovery circuit which comprises adding to a first and a subsequent stage of said circuit flocculents having different compositions with a reduced dosage at the subsequent stage.

### SUMMARY OF INVENTION

The applicant has carried out research and development work in relation to the solid/liquor separation step (b).

The applicant found in the research and development work that the addition of a flocculent, typically small amounts of the flocculent, to a process slurry produced in a digestion step of the Bayer process to promote formation of aggregates of solid material in the process slurry under conditions that cause mixing, typically vigorous mixing, of the flocculent and the slurry improves subsequent solid/liquid separation in a settling tank.

More particularly, the applicant found that the addition of the flocculent at different stages with different extent of mixing improves even further subsequent solid/liquid separation in a settling tank.

According to the present invention there is provided a method of separating solid and liquor components of a process slurry produced in a hydrometallurgical process, the process slurry comprising solid material entrained in a liquor, the method comprising:
(a) a pre-treatment step of adding a flocculent to the process slurry and mixing the flocculent and the slurry by selecting a higher extent of mixing in an early stage of said step than in a later stage of said step, and
(b) a solid/liquor separation step of allowing separation of solid material, including aggregates of solid material, and liquor of the slurry to produce process outputs of a clarified liquor and solid material with some entrained liquor.

The overall objective of pre-treatment step (a) is to promote the formation of aggregates of solid material in the slurry that in turn facilitate separation of solid material and the liquor in step (b). The purpose of mixing the flocculent and the process slurry in the pre-treatment step is to (i) increase the probability of contact between the flocculent and solid material in the slurry and (ii) maintain a dispersion, preferably a homogeneous dispersion, of solid material, including any aggregates of solid material that form, in the slurry and to minimise settling of solid material in the apparatus used in the pre-treatment step and (iii) allow the aggregates to grow to a size suitable to facilitate separation of solid material, including aggregates of solid material, and the liquor in the settling tank.

The purpose of the selection of the extent of the mixing is to (i) enhance the probability of contact of the solid material and the flocculent in the early stage of the pre-treatment step and (ii) promote aggregate formation while maintaining a dispersion of the solid material, including any aggregates that may form, in the process slurry.

Pre-treatment step (a) may comprise varying the flocculent dosage rate during the course of the step. Pre-treatment step (a) may comprise selecting a higher dosage rate in an early stage of the step than in a later stage of the step.

The reason for the above selections of the extent of the mixing and the dosage rates is to (i) further enhance the probability of contact of the solid material and the flocculent in the early stage of the pre-treatment step and (ii) further promote aggregate formation while maintaining a dispersion of the solid material, including any aggregates that may form, in the process slurry.

The process slurry may be a process slurry from the Bayer process.

The slurry may be a process slurry from a digestion step of the Bayer process.

The process slurry may comprise (i) a liquor containing sodium aluminate in solution and (ii) solid material.

The flocculent may be any suitable flocculent.

Pre-treatment step (a) may comprise adding a small amount of the flocculent to the process slurry. The addition of the flocculent may be continuous during the pre-treatment step.

The total amount of the flocculent added to the process slurry in pre-treatment step (a) may be less than 300 g of the flocculent per tonne of solid material in the process slurry.

The total amount of the flocculent may be less than 200 g/t solid material.

The total amount of the flocculent may be less than 100 g/t solid material.

Pre-treatment step (a) may comprise adding the flocculent to a single tank and mixing the process slurry and the flocculent in said tank.

Pre-treatment step (a) may comprise varying the extent of mixing in the above mentioned single tank during the course of the step and, more particularly, selecting a higher extent of mixing in an early stage of the step than in a later stage of the step.

Pre-treatment step (a) may comprise varying the flocculent dosage rate into the above mentioned single tank during the course of the step and, more particularly, selecting a higher dosage rate in an early stage of the step than in a later stage of the step.

The reason for the above selections of the extent of the mixing and the dosage rates is to (i) enhance the probability of contact of the solid material and the flocculent in the early stage of the pre-treatment step in the tank and (ii) promote aggregate formation in the tank while maintaining a dispersion of the solid material, including any aggregates that may form in the tank, in the process slurry in the tank.

Pre-treatment step (a) may comprise mixing the process slurry and the flocculent in the tank via stirrers or other suitable mechanical agitators in the tank.

Pre-treatment step (a) may comprise passing the process slurry successively through each of a is series of tanks and adding the flocculent to at least two of the tanks or upstream of the tanks and mixing the process slurry and the flocculent in the tanks.

Pre-treatment step (a) may comprise mixing the process slurry and the flocculent in the tanks via stirrers or other suitable mechanical agitators in the tanks.

Pre-treatment step (a) may comprise selecting the extent of mixing in a first tank of the series of tanks that is higher than the extent of mixing in a final tank of the series of tanks.

In a situation in which there is at least 3 tanks and mixing is via stirrers that are mounted to rotating shafts in at least the first and the third tanks, the mixing rate may be such that the speed at the tip of the stirrers is between 0.5 and 5 m/s, preferably between 0.5 and 2.5 m/s in any of the tanks.

Pre-treatment step (a) may comprise varying the extent of mixing in at least one of the tanks in the series of tanks during the course of the step.

Pre-treatment step (a) may comprise selecting a flocculent dosage rate in a first tank of the series of tanks that is higher then the flocculent dosage rate in a final tank of the series of tanks.

Pre-treatment step (a) may comprise varying the flocculent dosage rate in at least one of the tanks of the series of tanks during the course of the step.

Pre-treatment step (a) may comprise selecting an amount of the flocculent added in a first tank of the series of tanks that is greater than the amount of the flocculent addition in each successive tank of the series of tanks.

In a situation in which there is 3 tanks and the flocculent is added to each of the tanks, 25-70% of the total amount of the flocculent may be added in a first tank, 15-35% of the flocculent may be added in a second tank that is downstream of the first tank, and 10-60% of the flocculent may be added in a third tank that is downstream of the second tank.

Pre-treatment step (a) may comprise selecting a residence time of 1-5 minutes for the slurry in the tank or tanks.

Pre-treatment step (a) may comprise passing the process slurry through an in-line mixer and adding the flocculent to the process slurry in the in-line mixer.

Pre-treatment step (a) may comprise adding the flocculent to the process slurry at multiple locations along the length of the in-line mixer.

Pre-treatment step (a) may comprise adding different dosage rates of the flocculent at the multiple locations during the course of the step.

Pre-treatment step (a) may comprise varying the dosage rate of the flocculent at each of the multiple locations during the course of the step.

The in-line mixer may be in the form of a tube, with an inlet for the process slurry and an outlet for the mixed process slurry and the flocculent, and with multiple locations for supplying the flocculent to the process slurry flowing through the tube.

The multiple locations may comprise the inlet and at least two locations along the length of the tube.

The in-line mixer may further comprise baffles within the tube along the length of the tube that minimise laminar flow along the side wall of the tube.

Pre-treatment step (a) may comprise transferring the mixture of the process slurry and the flocculent from the outlet of the in-line mixer to a tank and mixing the slurry/flocculent in the tank. The experimental work carried out by the applicant showed that in certain situations the combination of mixing in (i) the in-line mixer and (ii) the tank produced optimum results.

According to the present invention there is also provided a method of adding a flocculent to a hydrometallurgical process slurry, that comprises solid material entrained in a liquor, the process comprising adding the flocculent to the process slurry and mixing the flocculent and the process slurry to promote formation of aggregates of solid material in the process slurry and to maintain a dispersion of solid material, including any aggregates of solid material that form, in the process slurry and to minimise settling of solid material in an apparatus used in the method.

According to the present invention there is also provided an apparatus for separating solid and liquor components of a process slurry produced in a hydrometallurgical process, the process slurry comprising solid material entrained in a liquor, the apparatus comprising:
(a) pre-treatment apparatus for adding a flocculent to the process slurry and mixing the flocculent and the slurry together to facilitate forming aggregates of solid material of the process slurry and to maintain a dispersion of solid material, including aggregates of solid material, in the slurry and to minimise settling of solid material in the apparatus, and
(b) solid/liquor separation apparatus for allowing separation of solid material, including any aggregates of solid material that form, and liquor of the process slurry to produce (i) a clarified liquor and (ii) solids some entrained liquor.

The pre-treatment apparatus may comprise one tank with a flocculent addition system and an inlet for the process slurry and an outlet for a mixture of the process slurry and the flocculent and a system to provide agitation in the tank.

The pre-treatment apparatus may comprise a series of interconnected tanks, with each tank comprising a flocculent addition system and an inlet for the process slurry and an outlet for a mixture of the process slurry and the flocculent, and with the outlet of the first tank in the series connected to the inlet of the successive tank in the series so that, in use, the process slurry flows successively through the tanks and systems to provide agitation in the tanks.

Alternatively, the pre-treatment apparatus may comprise an in-line mixer with a flocculent addition system and an inlet for the process slurry and an outlet for a mixture of the process slurry and the flocculent.

The in-line mixer may be in the form of a tube, with an inlet for the process slurry and an outlet for the mixture of the process slurry and the flocculent, and with multiple locations for supplying the flocculent to the process slurry flowing through the tube.

The multiple locations may comprise the inlet end and at least two locations along the length of the tube.

The in-line mixer may further comprise baffles along the length of the tube that minimise laminar flow along the side wall of the tube.

The solid/liquor separation apparatus may be in the form of a settling tank, with an inlet for the mixture of the process slurry and the flocculent and an overflow outlet for the clarified liquor and an outlet for separated solid material and any entrained liquor.

The process slurry may be a Bayer process slurry.

### BRIEF DESCRIPTION OF DRAWINGS

The present invention is described further by way of example with reference to the accompanying drawings, of which:

FIG. 1 is a diagram that illustrates a section of a Bayer process in accordance with an embodiment of the present invention; and

FIG. 2 is a diagram that illustrates a section of a Bayer process in accordance with another embodiment of the present invention.

### DESCRIPTION OF EMBODIMENTS

The Figures illustrate two embodiments of the method and apparatus for separating solid and liquor components of a process slurry produced in a Bayer process in accordance with the present invention.

The embodiments are described hereinafter in the context of a process slurry that is produced in digestion units of Bayer process plants for producing alumina. As is indicated above, the present invention is not limited to Bayer process slurries. The process slurry comprises (i) a liquor containing sodium aluminate in solution and (ii) solid material, typically in the form of fine particulate material.

The embodiments are based on the addition of small amounts of a flocculent under agitated conditions in a pre-treatment step upstream of one or more than one tank, such as a decanter, for allowing separation of solids and liquor of the process slurry. The embodiments are two of a number of possible embodiments of the method and the apparatus of the present invention.

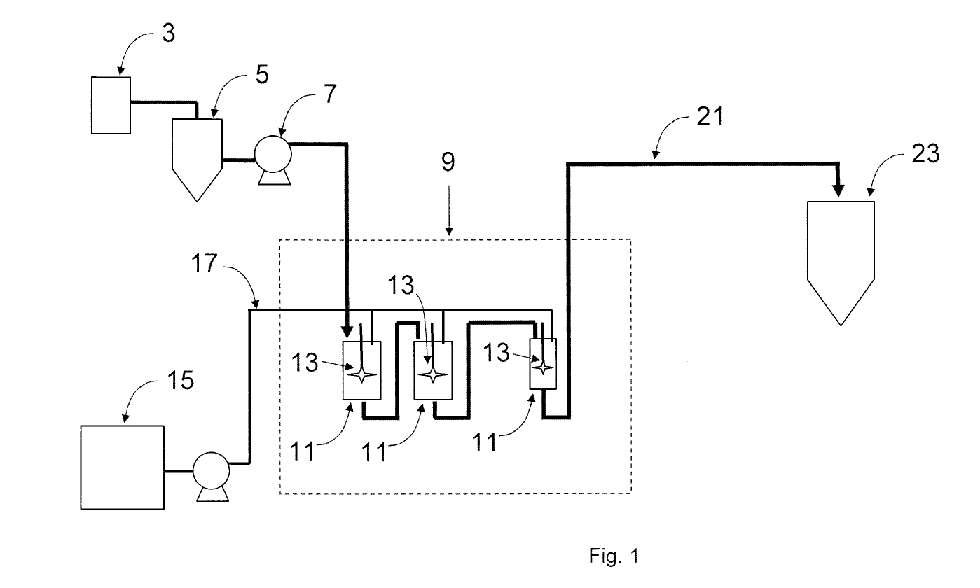

With reference to FIG. 1, a process slurry from a digestion unit 3 is flash-cooled to ambient temperature and pressure in a series of flash tanks 5 and then pumped by means of a pump 7 to a pre-treatment apparatus generally identified by the numeral 9. A flocculent is added to the process slurry via a flocculent addition system as it flows through the pre-treatment apparatus 9. Typically, the residence time of the process slurry in the pretreatment apparatus 9 is 1-5 minutes. The flocculent may be any suitable flocculent. For Bayer slurries, the flocculent may be a polyacrylate or an hydroxamate. The resultant mixture of the process slurry and flocculent is transferred via a line 21 to a decanter 23. The solid and liquor components of the mixture separate in the decanter 23 to produce (i) a clarified liquor and (ii) solids with some entrained liquor.

The pre-treatment apparatus 9 comprises three pre-treatment tanks arranged in series, with process slurry inlets in upper sections of the tanks and process liquor outlets in lower sections of the tanks. The process slurry flows serially through the tanks so that 100% of the process slurry flows through each of the tanks 11. The tanks 11 are fitted with stirrers 13 that have variable drives that make it possible to rotate the stirrers at different rates in each tank and at different rates within a tank depending on the process requirements. The flocculent is pumped to each of the tanks 11 from a flocculent preparation station 15 via a line 17. The arrangement is such that it is possible to vary the dosage rate of the flocculent to each tank 11 and within a tank depending on the process requirements.

In one operating set-up tested by the applicant, the first tank 11 (i.e. the one most upstream of the decanter 23) receives 60% of the flocculent, the second tank 11 receives 30% of the flocculent, and the third tank 11 receives 10% A of the flocculent. It is emphasised that the present invention is not confined to these amounts and, moreover, the present invention extends to varying these amounts in each tank 11 during the course of the process, for example to accommodate changes in characteristics of the process slurry. In general terms, 25-70% of the total amount of the flocculent is added in the first tank 11, 15-35% of the flocculent is added in the second tank 11, and 10-60% of the flocculent is added in the third tank 11. The first tank 11 has a higher level of agitation compared to the other tanks 11. The second and third tanks 11 have progressively lower levels of agitation compared to the first tank 11. Again, the present invention extends to varying the amounts of agitation in each tank 11 during the course of the process.

to The overall objective of the selection of the dosage rates and mixing rates in accordance with the present invention is to achieve high levels of contact of the flocculent and the solid material in the process slurry and to maintain a dispersion, preferably a homogeneous dispersion, of the solid material, including any aggregates of solid material that form, in the process slurry to minimise settling out of the solid material in the tanks 11 and to allow aggregates to grow to a size suitable to facilitate separation of solid material from the liquor in the decanter 23.

In the course of experimental work in relation to the FIG. 1 embodiment, the applicant observed (a) good flocculation with this arrangement of tanks 11 and this selection of mixing and dosage rates for the tanks 11 and (b) significantly greater clarity of overflow liquor than with conventional arrangements that did not include pre-treatment of the process liquor upstream of the decanter 23 and relied on addition of the flocculent in the decanter 23.

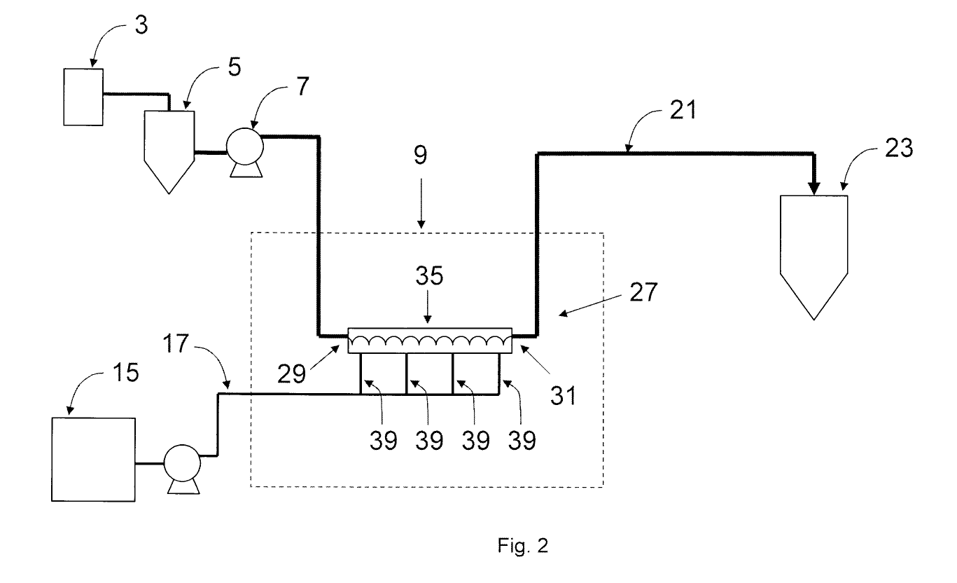

The process flow sheet shown in FIG. 2 is basically the same as that of FIG. 1 and the same reference numerals are used to describe the same features in both Figures.

The main difference between the two embodiments is the way in which the flocculent is added and mixed to the process slurry.

Specifically, the pre-treatment apparatus 9 in the FIG. 2 embodiment is in the form of an in-line mixer 27 having a flocculent addition system (described below).

The in-line mixer 27 is in the form of a tube 35 having an inlet 29 for the process slurry and an outlet 31 for the mixture of the process slurry and the flocculent.

In addition, the tube 35 has multiple injection points 39 for supplying the flocculent to the process slurry flowing through the tube 35. The multiple injection points 39 shown in FIG. 2 comprise the inlet 29 and at least three locations spaced equi-distantly along the length of the tube 35. It is emphasised that the present invention is not confined to this arrangement and extends to any suitable number and location of injection points 39 in the tube 35. These multiple injection points 39 form part of the flocculent addition system, along with the flocculent preparation station 15 and the distribution line 17. In one operating set-up tested by the applicant, the flocculent is supplied to the tube 35 with progressively lower dosage rates along the length of the tube from the inlet 29 to the outlet 31.

The in-line mixer 27 further comprises a series of baffles (not shown) along the length of the tube 35 that minimise laminar flow along the side wall of the tube.

In the course of experimental work in relation to the FIG. 2 embodiment, the applicant observed (a) good flocculation and (b) significantly greater clarity of overflow liquor than with conventional arrangements that did not include pre-treatment of the process liquor upstream of the decanter 23 and relied on addition of the flocculent in the decanter 23.

As mentioned above, the applicant has carried out experimental work on the arrangements shown in FIGS. 1 and 2 and conventional arrangements that did not include pre-treatment of the process liquor upstream of the settling decanters 23 and relied solely on addition of the flocculent in the decanters 23. The experimental work produced overflow clarities from the decanters 23 of less than 10 ppm for both embodiments. This is a significant improvement in performance compared to overflow clarities of 100-250 ppm and sometime as high as 500 ppm from the decanters 23 of the conventional arrangements.

It is noted that clarity was measured by filtering a known volume (typically 100 mL) of overflow slurry on a 0.45 micron Micropore filter. The filter was washed and dried in an oven overnight. The weight of the solid residue on the paper was used to compute the ppm of solids.

Many modifications may be made to the embodiments of the present invention described above without departing from the spirit and scope of the invention.

1. A method for separating solid and liquor components of a process slurry, said process slurry comprising solid material entrained in a liquor, said method comprising:
(a) a pre-treatment step of adding a flocculent to the process slurry and mixing the flocculent and the slurry by selecting a higher rate of mixing in an early stage of said pre-treatment step than in a later stage of said pre-treatment step, and
(b) a solid/liquor separation step of allowing separation of solid material, including aggregates of solid material, and liquor of said process slurry to produce process outputs of a clarified liquor and solid material with some entrained liquor.

2. A method according to claim 1, wherein the pre-treatment step (a) comprises varying the flocculent dosage rate during the course of the pre-treatment step.

3. A method according to claim 2, wherein the pre-treatment step (a) comprises selecting a higher dosage rate in the early stage of the pre-treatment step than in the later stage of the pre-treatment step.

4. A method according to claim 1, wherein the pre-treatment step (a) comprises adding the flocculent to a single tank and mixing the process slurry and the flocculent in said tank.

5. A method according to claim 1, wherein the pre-treatment step (a) comprises passing the process slurry successively through each of a series of tanks and adding the flocculent to at least two of the tanks or upstream of the tanks and mixing the process slurry and the flocculent in the tanks by selecting the rate of mixing in a first tank of the series of tanks that is higher than the rate of mixing in a final tank of the series of tanks

6. A method according to claim 5, wherein the series of tanks includes at least 3 tanks, and the pre-treatment step (a) comprises passing the process slurry successively through each of the series of at least 3 tanks and the mixing is performed via stirrers that are mounted to rotating shafts in at least the first tank and a third tank that is downstream of the first tanks.

7. A method according to claim 6, wherein the rate of mixing is such that a speed at a tip of the stirrers is between 0.5 and 5 m/s in any of the tanks

8. A method according to claim 6, wherein the flocculent is added to each of the tanks, 25-70% of the total amount of the flocculent is added in the first tank, 15-35% of the flocculent is added in a second tank that is downstream of the first tank, and 10-60% of the flocculent is added in a-the third tank that is downstream of the second tank.

9. A method according to claim 4, wherein the pre-treatment step (a) comprises selecting a residence time of 1-5 minutes for the slurry in the tank.

10. A method according to claim 1, wherein the pre-treatment step (a) comprises passing the process slurry through an in-line mixer and adding the flocculent to the process slurry in the in-line mixer.

11. A method according to claim 10, wherein the pre-treatment step (a) comprises adding the flocculent to the process slurry at multiple locations along a length of the in-line mixer.

12. A method according to claim 10, wherein the in-line mixer is in the form of a tube, with an inlet for the process slurry and an outlet for the mixed process slurry and the flocculent, and with multiple locations for supplying the flocculent to the process slurry flowing through the tube.

13. A method according to claim 12, wherein the multiple locations comprise the inlet and at least two locations along a length of the tube.

14. A method according to claim 12, wherein the in-line mixer further comprises baffles within the tube along a length of the tube that minimise laminar flow along a side wall of the tube.

15. A method according to claim 12, wherein the pre-treatment step (a) comprises transferring a mixture of the process slurry and the flocculent from the outlet of the in-line mixer to a tank and mixing the slurry/flocculent in said tank.

16. A method of adding a flocculent to a process slurry, that comprises solid material entrained in a liquor, the process comprising adding the flocculent to the process slurry and mixing the flocculent and the process slurry by selecting a higher rate of mixing in an early stage than in a later stage.

17. An apparatus for separating solid and liquor components of a process slurry comprising solid material entrained in a liquor, the apparatus comprising:
(a) pre-treatment apparatus configured for adding a flocculent to the process slurry and mixing the flocculent and the slurry together provided with means for selecting a higher rate of mixing in an early stage the pre-treatment than in a later stage of said pre-treatment, and (b) solid/liquor separation apparatus configured for allowing separation of solid material, including any aggregates of solid material that form, and liquor of the process slurry to produce (i) a clarified liquor and (ii) solids with some entrained liquor.

18. An apparatus according to claim 17, wherein the pre-treatment apparatus comprises one tank with a flocculent addition system and an inlet for the process slurry and an outlet for a mixture of the process slurry and the flocculent and a system to provide agitation in the tank.

19. An apparatus according to claim 17, wherein the pre-treatment apparatus comprises a series of interconnected tanks, with each tank comprising a flocculent addition system and an inlet for the process slurry and an outlet for a mixture of the process slurry and the flocculent, and with the outlet of a first tank in the series connected to the inlet of a successive tank in the series so that, in use, the process slurry flows successively through the tanks and systems to provide agitation in the tanks

20. An apparatus according to claim 17, wherein the pre-treatment apparatus comprises an in-line mixer with a flocculent addition system and an inlet for the process slurry and an outlet for a mixture of the process slurry and the flocculent.

21. An apparatus according to claim 20, wherein the in-line mixer is in the form of a tube, with an inlet for the process slurry and an outlet for a mixture of the process slurry and the flocculent, and with multiple locations for supplying the flocculent to the process slurry flowing through the tube.

22. An apparatus according to claim 21, wherein the multiple locations comprise the inlet and at least two locations along a length of the tube.

23. An apparatus according to claim 21, wherein the in-line mixer further comprises baffles along a length of the tube that minimise laminar flow along a side wall of the tube.

24. An apparatus according to claim 17, wherein the solid/liquor separation apparatus is in the form of a settling tank, with an inlet for the mixture of the process slurry and the flocculent and an overflow outlet for the clarified liquor and an outlet for separated solid material and any entrained liquor.
